(19) United States
(12) Patent Application Publication
(10) Pub. No.: US 2017/0075503 A1
(43) Pub. Date: Mar. 16, 2017

(54) SYSTEM AND METHOD FOR ENHANCED COLLABORATION

(71) Applicant: International Business Machines Corporation, Armonk, NY (US)

(72) Inventors: Al Chakra, Apex, NC (US); Saurabh Gupta, Hillsborough, NC (US); Nancy A. Schipon, Apex, NC (US); Aaron M. Young, Raleigh, NC (US)

(21) Appl. No.: 14/850,000

(22) Filed: Sep. 10, 2015

(51) Int. Cl. G06F 3/0481; H04L 29/08

(52) U.S. Cl. CPC G06F 3/0481; H04L 67/141

(57) ABSTRACT

A method, computer program product, and computer system for identifying a plurality of sections of a user interface associated with a collaboration session. An assigned first section of the plurality of sections of the user interface may be identified as a first screen share of a first computing device. An assigned second section of the plurality of sections of the user interface may be identified as a second screen share of a second computing device. Control rules may be applied for display of the first section and the second section of the user interface to at least a portion of participants connected to the collaboration session.

### BACKGROUND

The present invention relates generally to collaboration during online communication. More specifically, the present invention relates to enhancing capabilities of user interfaces for collaborative environments.

Virtual meeting or online communication technology may enable people in various locations to collaborate. Generally, online meeting applications may be limited to one person controlling the user interface screen that is viewed by the other online meeting attendees. As such, this may result in only one event being viewed by the attendees at a time, which may hinder productivity.

### SUMMARY OF THE INVENTION

In one example implementation, a method, performed by one or more computing devices, may include but is not limited to identifying, by a computing device, a plurality of sections of a user interface associated with a collaboration session. An assigned first section of the plurality of sections of the user interface may be identified as a first screen share of a first computing device. An assigned second section of the plurality of sections of the user interface may be identified as a second screen share of a second computing device. Control rules may be applied for display of the first section and the second section of the user interface to at least a portion of participants connected to the collaboration session.

In another example implementation, a computing system includes a processor and a memory configured to perform operations that may include but are not limited to identifying a plurality of sections of a user interface associated with a collaboration session. An assigned first section of the plurality of sections of the user interface may be identified as a first screen share of a first computing device. An assigned second section of the plurality of sections of the user interface may be identified as a second screen share of a second computing device. Control rules may be applied for display of the first section and the second section of the user interface to at least a portion of participants connected to the collaboration session.

In another example implementation, a computer program product resides on a computer readable storage medium that has a plurality of instructions stored on it. When executed by a processor, the instructions cause the processor to perform operations that may include but are not limited to identifying a plurality of sections of a user interface associated with a collaboration session. An assigned first section of the plurality of sections of the user interface may be identified as a first screen share of a first computing device. An assigned second section of the plurality of sections of the user interface may be identified as a second screen share of a second computing device. Control rules may be applied for display of the first section and the second section of the user interface to at least a portion of participants connected to the collaboration session.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a display process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the display process of FIG. 1 according to one or more example implementations of the disclosure;

FIG. 4 is an example diagrammatic view of a screen image displayed by the display process of FIG. 1 according to one or more example implementations of the disclosure;

FIG. 5 is an example diagrammatic view of a screen image displayed by the display process of FIG. 1 according to one or more example implementations of the disclosure;

FIG. 6 is an example diagrammatic view of a screen image displayed by the display process of FIG. 1 according to one or more example implementations of the disclosure;

FIG. 7 is an example diagrammatic view of a screen image displayed by the display process of FIG. 1 according to one or more example implementations of the disclosure;

FIG. 8 is an example diagrammatic view of a tag cloud displayed by the display process of FIG. 1 according to one or more example implementations of the disclosure; and

FIG. 9 is an example diagrammatic view of a screen image displayed by the display process of FIG. 1 according to one or more example implementations of the disclosure.

Like reference symbols in the various drawings indicate like elements.

### DETAILED DESCRIPTION

### System Overview:

One or more of the following example features may be included in one or more of the example implementations. Applying control rules may include applying a display filter to at least one of the first section and the second section of the user interface. The display filter may include a tag cloud based filtering. The display filter may include a group based filtering. The display filter may include a maximum number of sections of the user interface to be displayed. Applying control rules may include preventing access to at least one of the first section and the second section of the user interface from one or more participants of at least the portion of participants connected to the collaboration session. Applying control rules may include enabling individualized reorganization of the user interface from one or more participants of at least the portion of participants connected to the collaboration session.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

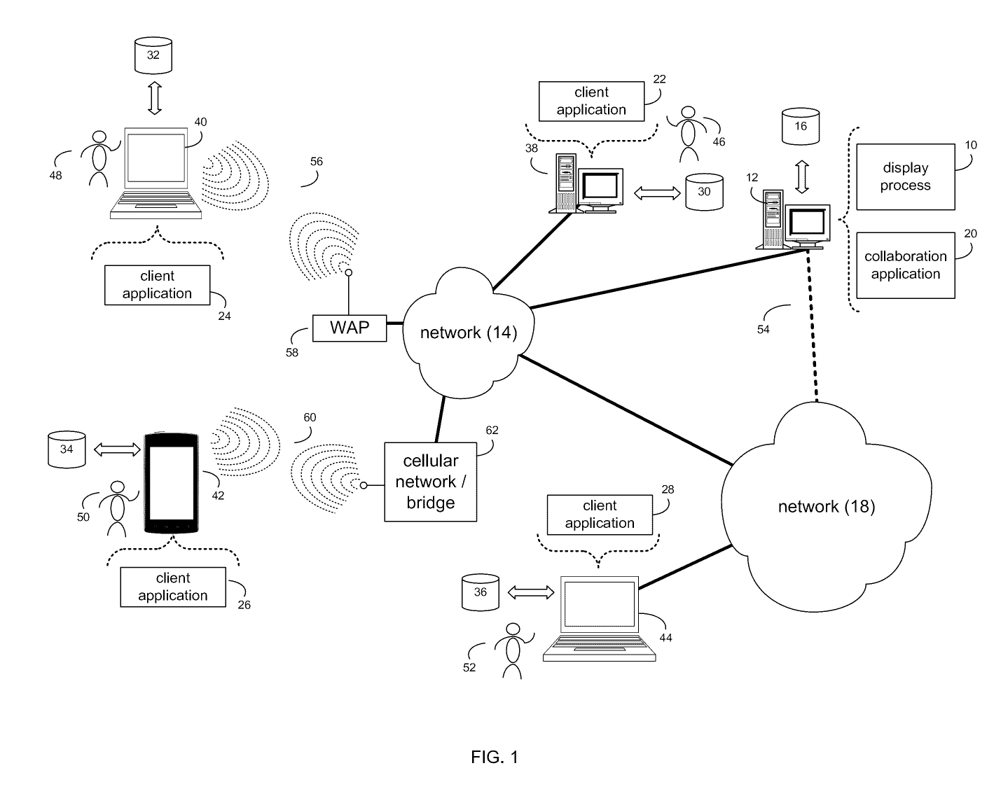

Referring now to FIG. 1, there is shown display process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, display process 10 may identify a plurality of sections of a user interface associated with a collaboration session. An assigned first section of the plurality of sections of the user interface may be identified as a first screen share of a first computing device. An assigned second section of the plurality of sections of the user interface may be identified as a second screen share of a second computing device. Control rules may be applied for display of the first section and the second section of the user interface to at least a portion of participants connected to the collaboration session.

The instruction sets and subroutines of display process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. The data store may also be a custom database, such as, for example, a flat file database or an XML database. Any other form(s) of a data storage structure and/or organization may also be used. Display process 10 may be a component of the data store, a standalone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a collaboration application (e.g., collaboration application 20), examples of which may include, but are not limited to, e.g., a web conferencing application, a video conferencing application, a voice-over-IP application, a video-over-IP application, an Instant Messaging (IM)/“chat” application, a screen sharing application, a short messaging service (SMS)/multimedia messaging service (MMS) application, or other application that allows for virtual meeting and/or remote collaboration. Display process 10 and/or collaboration application 20 may be accessed via client applications 22, 24, 26, 28. Display process 10 may be a standalone application, or may be an applet/application/script/extension that may interact with and/or be executed within collaboration application 20, a component of collaboration application 20, and/or one or more of client applications 22, 24, 26, 28. Collaboration application 20 may be a standalone application, or may be an applet/application/script/extension that may interact with and/or be executed within display process 10, a component of display process 10, and/or one or more of client applications 22, 24, 26, 28. One or more of client applications 22, 24, 26, 28 may be a standalone application, or may be an applet/application/script/extension that may interact with and/or be executed within and/or be a component of display process 10 and/or collaboration application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, a screen sharing application, a short messaging service (SMS)/multimedia messaging service (MMS) application, or other application that allows for virtual meeting and/or remote collaboration, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of display process 10 (and vice versa). Accordingly, display process 10 may be a purely server-side application, a purely client-side application, or a hybrid server-side/client-side application that is cooperatively executed by one or more of client applications 22, 24, 26, 28 and/or display process 10.

One or more of client applications 22, 24, 26, 28 may be configured to effectuate some or all of the functionality of collaboration application 20 (and vice versa). Accordingly, collaboration application 20 may be a purely server-side application, a purely client-side application, or a hybrid server-side/client-side application that is cooperatively executed by one or more of client applications 22, 24, 26, 28 and/or collaboration application 20. As one or more of client applications 22, 24, 26, 28, display process 10, and collaboration application 20, taken singly or in any combination, may effectuate some or all of the same functionality, any description of effectuating such functionality via one or more of client applications 22, 24, 26, 28, display process 10, collaboration application 20, or combination thereof, and any described interaction(s) between one or more of client applications 22, 24, 26, 28, display process 10, collaboration application 20, or combination thereof to effectuate such functionality, should be taken as an example only and not to limit the scope of the disclosure.

Users 46, 48, 50, 52 may access computer 12 and display process 10 (e.g., using one or more of client electronic devices 38, 40, 42, 44) directly through network 14 or through secondary network 18. Further, computer 12 may be connected to network 14 through secondary network 18, as illustrated with phantom link line 54. Display process 10 may include one or more user interfaces, such as browsers and textual or graphical user interfaces, through which users 46, 48, 50, 52 may access display process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

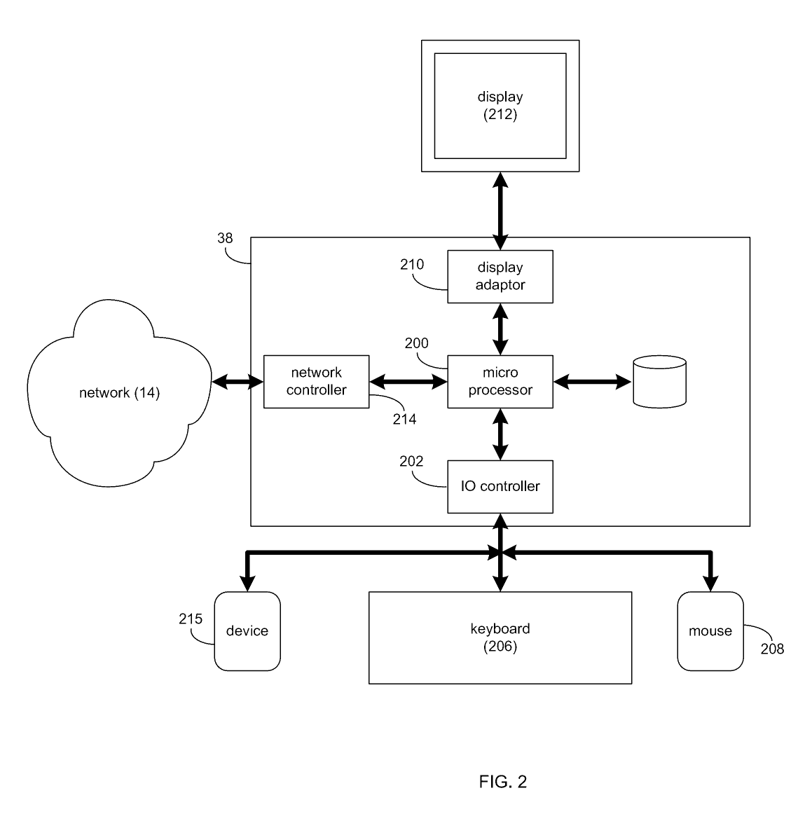

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, display process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports (not shown), and printer ports (not shown). A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

The Display Process:

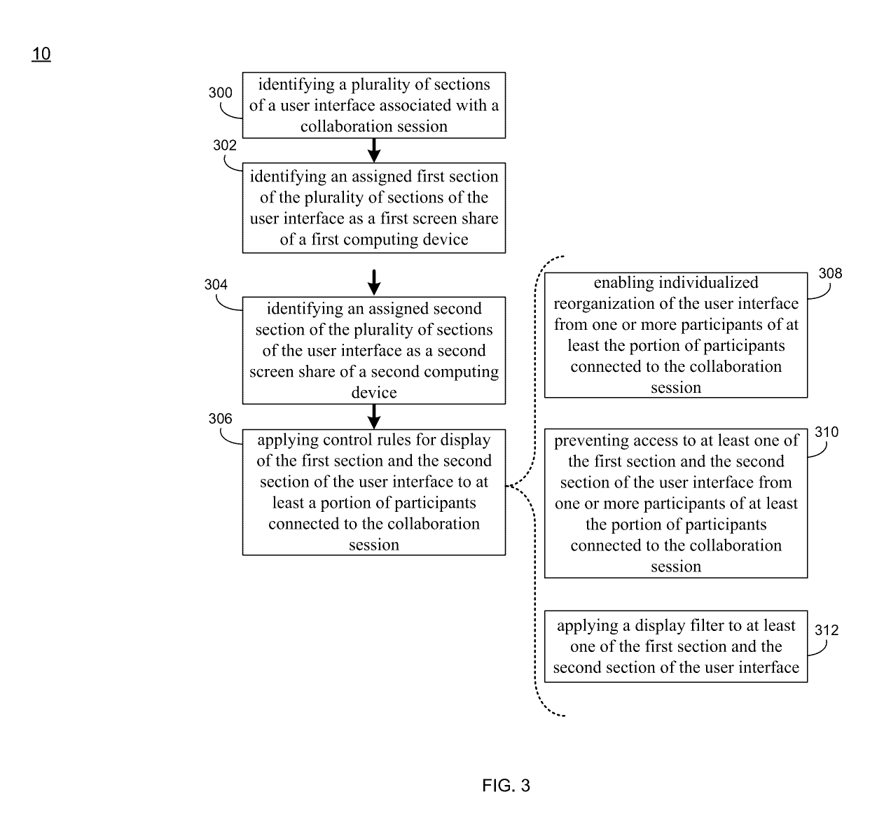

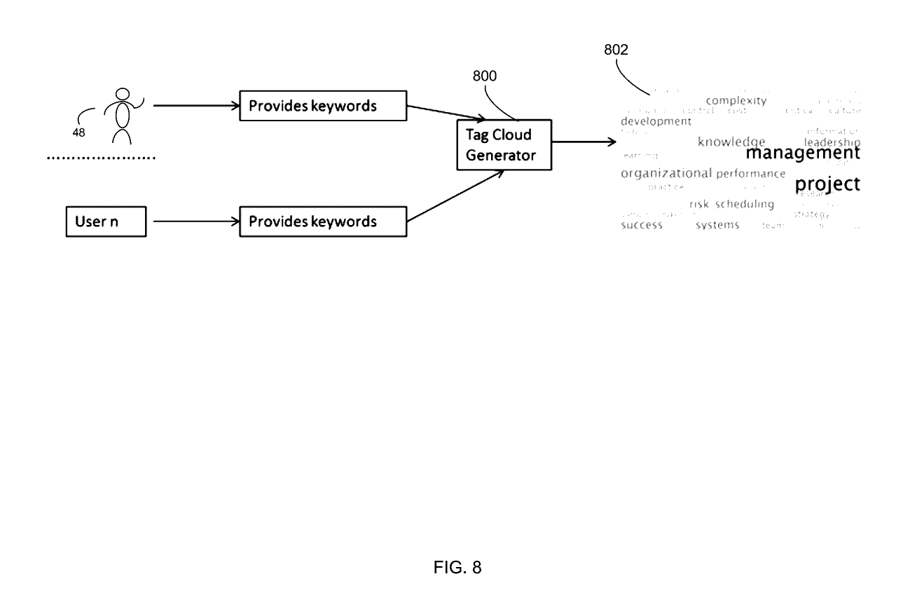

As discussed above and referring also at least to FIGS. 3-9, display process 10 may identify 300, by a computing device, a plurality of sections of a user interface associated with a collaboration session. An assigned first section of the plurality of sections of the user interface may be identified 302 by display process 10 as a first screen share of a first computing device. An assigned second section of the plurality of sections of the user interface may be identified 304 by display process 10 as a second screen share of a second computing device. Display process 10 may apply 306 control rules for display of the first section and the second section of the user interface to at least a portion of participants connected to the collaboration session.

As noted above, virtual meeting or online communication technology (such as those that may be provided by collaboration application 20) may enable people in various locations to collaborate. Generally, online meeting applications may be limited to one person controlling the user interface screen that is viewed by the other online meeting attendees. As such, this may result in only one event being viewed by the attendees at a time, which may hinder productivity. As will be discussed in greater detail below, display process 10 may enable each attendee to have control over their own allocated space on the screen being viewed by the attendees to be shared by multiple users simultaneously within the online meeting limit the sharing to particular attendees. For example, display process 10 on the same screen viewed by all attendees may enable one attendee demonstrating an install, while a customer goes through the install, while at the same time within the screen a document may be shown for reference. As another example, an instructor may display the steps to take to complete a calculus equation, and may keep the steps available on the screen as a reference, while watching one or more students perform a similar calculation to evaluate where they may have difficulty or for testing. As another example, so-called “war rooms”, where some additional access/visibility controls may be allocated on an individual or group bases, which may allow, e.g., business partners and internal teams to communicate amongst themselves within specified allocated space(s) on the screen being viewed by the attendees.

With, e.g., global commitments in the business industry and online education becoming more prevalent, an enhanced bidirectional user interface may promote communication. It will be appreciated that other example uses may benefit from the present disclosure.

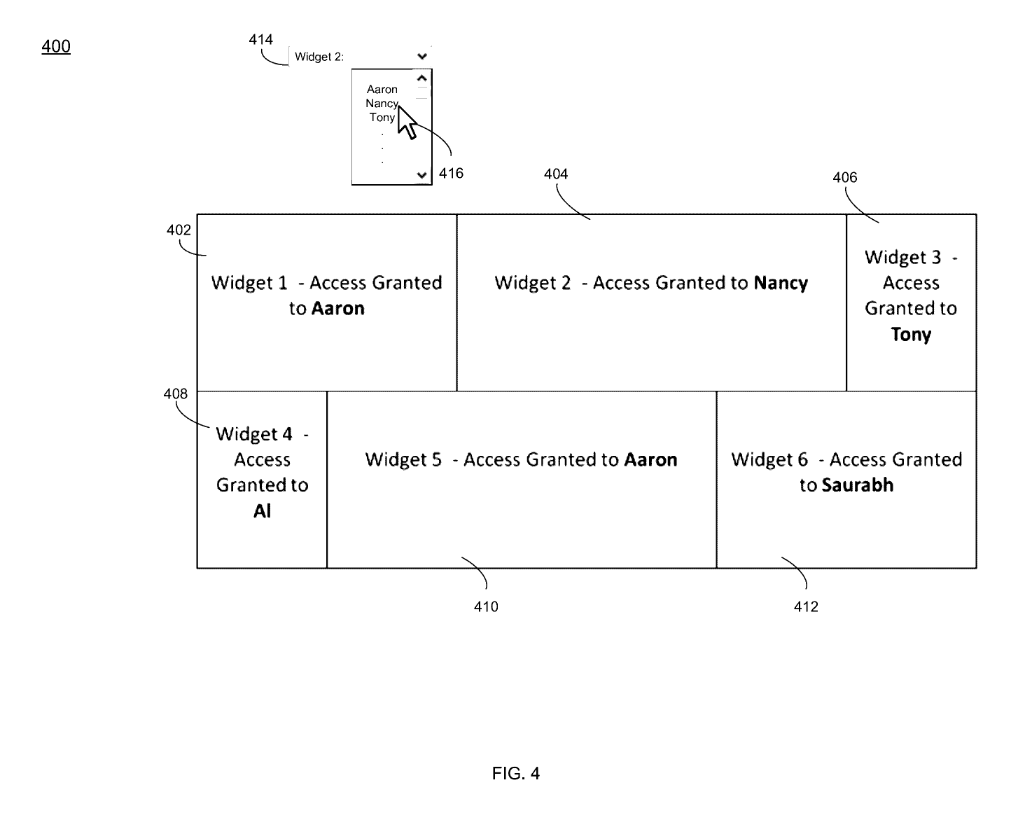

Assume for example purposes only that a collaboration session (e.g., an online meeting) is to take place between a plurality of users. In the example, the online meeting may have a meeting coordinator named Mike (e.g., user 46), and the participants include Aaron (e.g., user 48), Al (e.g., user 50), Nancy (e.g., user 52), Saurabh and Tony. In some implementations, display process 10 may identify 300 a plurality of sections of a user interface associated with a collaboration session. For example, and referring at least to FIG. 4, an example user interface (e.g., UI 400) associated with display process 10 is shown. In the example, the sections include section 402, 404, 406, 408, 410, and 412, and UI 400 may be the visual of the online meeting displayed on the screen of each meeting attendee. It will be appreciated that more or less sections may be used without departing from the scope of the disclosure.

In some implementations, an assigned first section of the plurality of sections of the user interface may be identified 302 by display process 10 as a first screen share of a first computing device, and an assigned second section of the plurality of sections of the user interface may be identified 304 by display process 10 as a second screen share of a second computing device. For instance, and continuing with the above example, Mike decides to divide his screen (shown as UI 400) into six “widgets” or sections. In the example, Aaron may be presenting two different pieces of content simultaneously while the others only may be presenting a single piece of content, and as such, Mike may (via display process 10) assign sections 1 and 5 to Aaron, section 2 to Nancy, section 3 to Tony, section 4 to Al, and section 6 to Saurabh, each of which may be identified 302/304 by display process 10. It will be appreciated that not all attendees of the collaboration session need to be assigned a section.

In some implementations, UI 400 may provide (via an additional UI object 414) Mike with the ability to allocate and assign more or less sections to more or less users, and may do so using any desired geometry or outlay. For example, display process 10 may enable Mike to use “drag and drop” boxes of various sizes (which may be resized as desired) to be assigned to each user (e.g., via a drop down menu) and organize each section as desired, using, e.g., cursor 416. It will be appreciated that other methods of assigning and designing UI 400 layout may be used without departing from the scope of the disclosure.

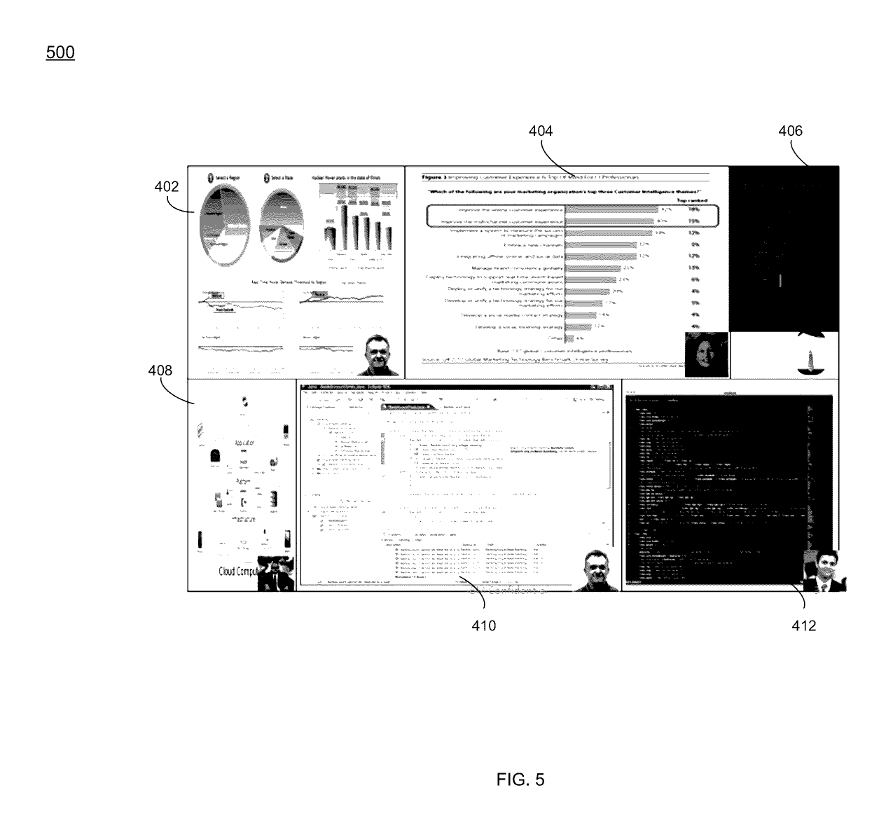

In some implementations, each assigned section may correspond to a “screen share” of the associated user's computing device, such that whatever is viewed on the respective screen of the assigned user's client electronic device may be mirrored (e.g., in real-time) in the assigned section of UI 400. This may be accomplished using known screen share techniques. For example, and referring at least to FIG. 5, an example screen capture 500 of the collaboration session (from UI 400) at a particular time during the collaboration session is shown. As can be seen, the sections from FIG. 4 correlate with the sections of FIG. 5. Thus, in the example, sections 1 (i.e., section 402) and 5 (i.e., section 410) correlate to the screen of Aaron's computing device, section 2 (i.e., section 404) correlates to the screen of Nancy's computing device, section 3 (i.e., section 406) correlates to the screen of Tony's computing device, section 4 (i.e., section 408) correlates to the screen of Al's computing device, and section 6 (i.e., section 412) correlates to the screen of Saurabh's computing device. In the example, at least a portion of the meeting participants/attendees connected to the collaboration session may view the collaboration session as shown in FIG. 5. In some implementations, an image or avatar of the user may be located in the appropriate section to alert the other users who is assigned a particular section. It will be appreciated that the sections need not be real-time mirrors of the user's entire screen, and may instead be assigned to specific applications being executed on the respective computing device. For example, section 1 (i.e., section 402) may correlate to a first application being executed on Aaron's computing device, and section 5 (i.e., section 410) may correlate to a second application being executed on Aaron's computing device. As another example, section 1 (i.e., section 402) may correlate to a first monitor being used by Aaron's computing device, and section 5 (i.e., section 410) may correlate to a second monitor being used by Aaron's computing device.

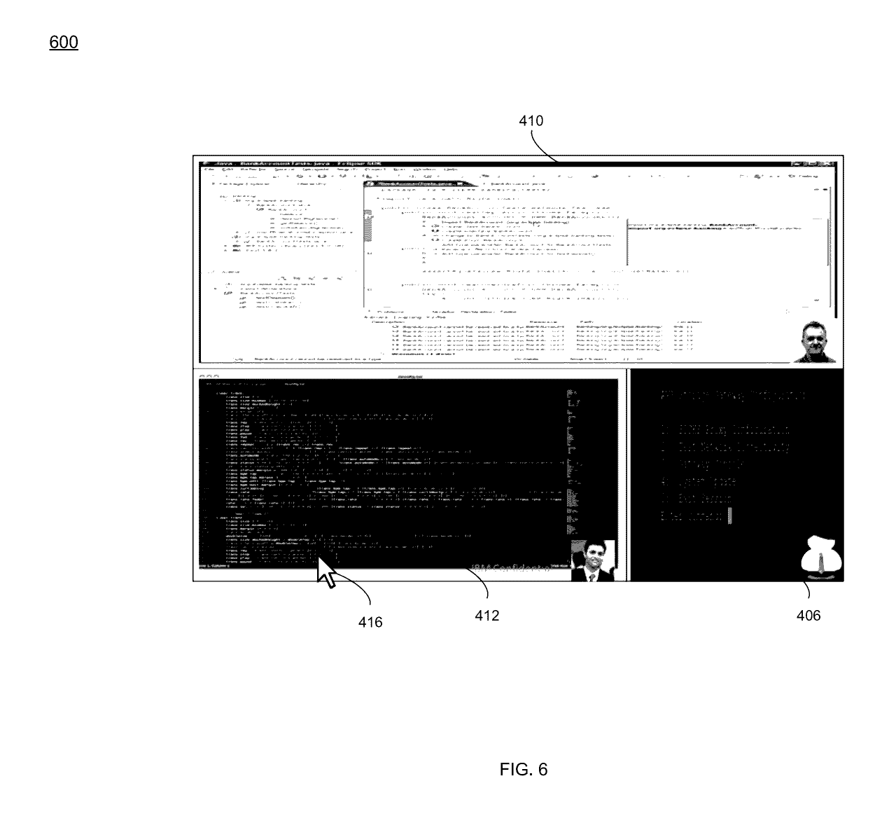

In some implementations, display process 10 may apply 306 control rules for display of the first section and the second section of the user interface to at least a portion of participants connected to the collaboration session. For example, applying 306 control rules may include enabling 308 individualized reorganization of the user interface from one or more participants of at least the portion of participants connected to the collaboration session. For example, and referring at least to FIG. 6, an example screen capture 600 of the collaboration session (from UI 400) at a particular time during the collaboration session is shown. As can be seen, some of the sections from FIG. 5 correlate with the sections of FIG. 6; however, in some implementations, Aaron (e.g., via cursor 416 and/or the enabling 308 by display process 10) may reorganize his personal view of the collaboration session as desired. Thus, in the example, Aaron (e.g., via display process 10) has removed section 1 (i.e., section 402), section 2 (i.e., section 404), and section 4 (i.e., section 408), while moving and reshaping section 3 (i.e., section 406), section 5 (i.e., section 410), and section 6 (i.e., section 412). In the example, Aaron may be the only meeting participant/attendee viewing the collaboration session as shown in FIG. 6, such that each meeting participant/attendee may view the collaboration session according to how they organize their UI. In some implementations, assuming the appropriate privileges are assigned to Aaron, the changes made to Aaron's personal view may be replicated by display process 10 to at least a portion of the meeting participants/attendees connected to the collaboration session as shown in FIG. 6.

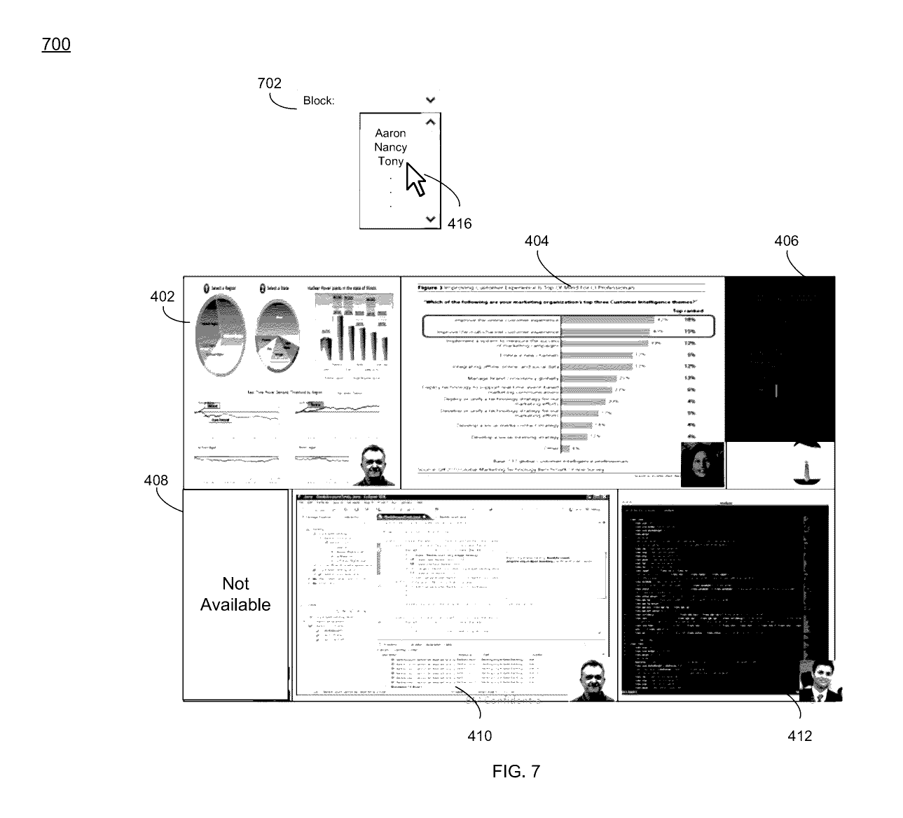

In some implementations, applying 306 control rules may include preventing 310 access to at least one of the first section and the second section of the user interface from one or more participants of at least the portion of participants connected to the collaboration session. For example, and referring at least to FIG. 7, an example screen capture 700 of the collaboration session (from UI 400) at a particular time during the collaboration session is shown. Assume for example purposes only that this particular view is the UI as seen from the display of Nancy. As can be seen, the sections from FIG. 5 correlate with the sections of FIG. 7; however, in some implementations, Al (e.g., via cursor 416 and/or display process 10) may decide that he does not wish Nancy to see what is on his screen at section 4 (i.e., section 408). Thus, in the example, Al may, e.g., send (via display process 10) a request to Mike asking him to block section 4 from the UI as viewed by Nancy. As a result of implementing the block, display process 10 may prevent 310 section 4 (i.e., section 408) from being displayed on the UI as viewed by Nancy by “redacting” that section on her UI. Thus, in the example, the other meeting participants/attendees viewing the collaboration session may still have access to section 4 as shown in FIG. 5, whereas Nancy may be viewing the collaboration session without access to section 4 as shown in FIG. 7. It will be appreciated that more or less meeting participants/attendees may be prevented 310 from viewing any portion of UI 700 without departing from the scope of the disclosure.

In some implementations, UI 700 may provide (via an additional UI object 702) meeting attendees with the ability to prevent 310 various sections from being displayed on the UI of particular attendees. For example, display process 10 may enable the respective attendee to assign to each attendee (e.g., via a drop down menu) restrictions to view their respective sections, using, e.g., cursor 416. It will be appreciated that other methods of assigning viewing privileges may be used without departing from the scope of the disclosure.

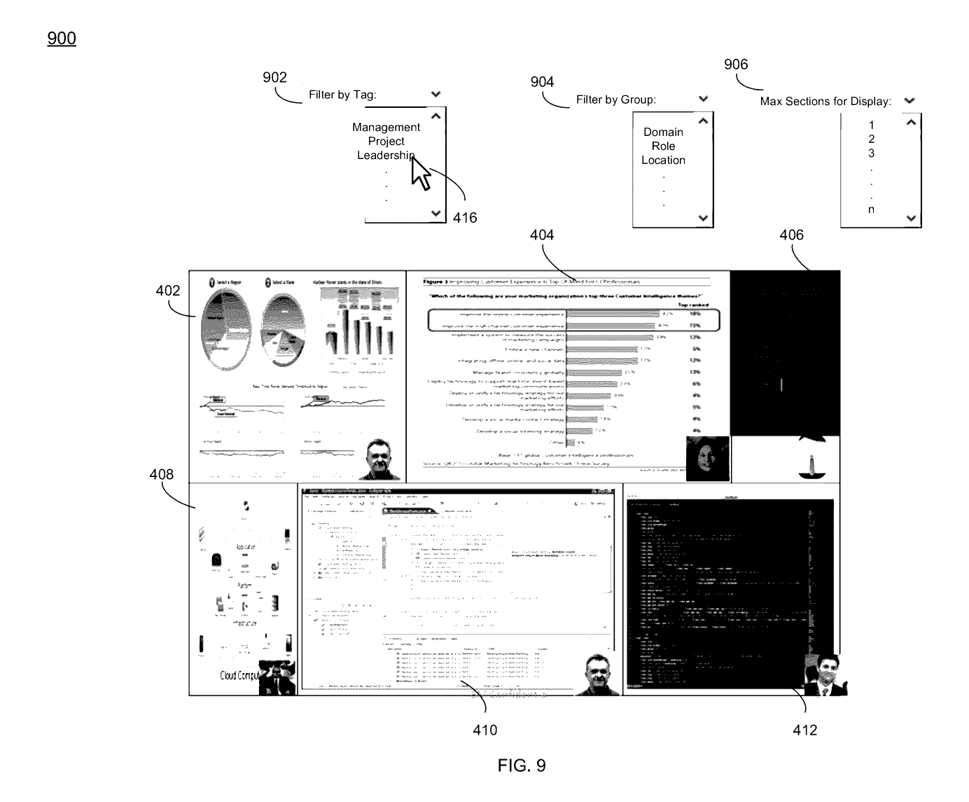

In some implementations, applying 306 control rules may include applying 312 a display filter to at least one of the first section and the second section of the user interface. For instance, as the number of screens shared increases, the meeting participants/attendees may want to filter the sections to focus on the sections of interest. In some implementations, the display filter may include a tag cloud based filtering. For instance, assume for example purposes only that at a time (e.g., before, during, after) when a meeting participant/attendee starts sharing their screen, they may be presented by display process 10 with a prompt to provide tag words that may represent the information that they will be sharing. Display process 10 may then use a tag cloud generator (e.g., tag cloud generator 800 to form and display a tag cloud (e.g., tag cloud 802) based on the tag words provided by at least a portion of the meeting participants/attendees sharing their screens. A tag cloud (e.g., a.k.a. word cloud, or weighted list in visual design) may be a visual representation for text data, typically used to depict keyword metadata (tags) on websites, or to visualize free form text. Tags may be single or multiple words, and the importance (or usage amounts) of each tag may be shown with, e.g., font size and/or color. For example, tags that are used more frequently may be larger in font and bolder in color than less frequently used tags. It will be appreciated that other designs to distinguish the frequency of tag usage may be used without departing from the scope of the disclosure. In some implementations, the meeting participant/attendee may, via display process 10, select tags from the tag cloud, which may present all the shared screens in a sorted order based upon tag usage. The list may be refreshed by display process 10 based on the selection of the keyword tag(s). In some implementations, display process 10 may enable the meeting participant/attendee to then select to display either the top n sections (e.g., based upon the tag) and/or select sections that should be displayed (e.g., based upon the tag). In some implementations, and referring at least to FIG. 9, UI 900 may provide (via an additional UI object 902) meeting attendees with the ability to select the tag associated with the sections for display. For example, display process 10 may enable the respective attendee to select (e.g., via a drop down menu and/or entered manually) the desired tag for filtering the sections, using, e.g., cursor 416. It will be appreciated that other methods of filtering and/or selecting the filtering tag may be used without departing from the scope of the disclosure. In some implementations, the tag cloud may be based upon text recognition by display process 10 of what is displayed in each respective section.

In some implementations, the display filter may include a group based filtering. For instance, at least a portion of the meeting participants/attendees may be classified into different groups. For instance, groups may be based upon, e.g., domain specific expertise (e.g., network group, storage group, etc.), business roles (e.g., subject matter experts, operators, managers, teachers, students, etc.), skills (e.g., developers, testers, quality assurance, etc.), location (e.g., North America, Asia, town, city, zip code, etc.). Display process 10 may obtain the information to classify the meeting participants/attendees based upon, e.g., profile information, solicited information, or other techniques. In some implementations, the meeting participant/attendee may, via display process 10, select groups from a list, which may present all the shared screens in a sorted order based upon the sections by group. In the example, and referring still at least to FIG. 9, UI 900 may provide (via an additional UI object 904) meeting attendees with the ability to select the group associated with the sections for display. For example, display process 10 may enable the respective attendee to select (e.g., via a drop down menu and/or entered manually) the desired group for filtering the sections, using, e.g., cursor 416. In some implementations, display process 10 may enable the meeting participant/attendee to then select to display either the top n sections (e.g., based upon the groups) and/or select sections that should be displayed (e.g., based upon the groups). It will be appreciated that other methods of filtering (e.g., by person) and/or selecting the filtering group may be used without departing from the scope of the disclosure.

In some implementations, the display filter may include a maximum number of sections of the user interface to be displayed. For instance, in some implementations, display process 10 may enable each of the meeting participants/attendees to set a maximum number of sections to be displayed at any given time. In the example, and referring still at least to FIG. 9, UI 900 may provide (via an additional UI object 906) meeting attendees with the ability to select the maximum number of sections to display. For example, display process 10 may enable the respective attendee to select (e.g., via a drop down menu and/or entered manually) the desired number of sections to be displayed, using, e.g., cursor 416. In some implementations, display process 10 may enable the meeting participant/attendee to select to display either the top n sections (e.g., based upon the maximum number of sections selected) and/or select sections that should be displayed (e.g., based upon the maximum number of sections selected). For example, assume for example purposes only that based upon filtering by tag cloud, that 20 sections are possible for display. In the example, further assume that the maximum number of sections to be displayed is set to 5. In the example, the top 5 out of the 20 sections may be displayed by display process 10, while the remaining 15 may not. It will be appreciated that other methods of selecting the maximum number of sections to display may be used without departing from the scope of the disclosure.

In some implementations, display process 10 may enable the ability for meeting participants/attendees to add various widgets in place of the sections. For example, Aaron may add a spreadsheet widget to section 1 (i.e., section 402). As another example, a webcam and/or IM window widget may be added to section 1 (i.e., section 402). Other example widgets may be added without departing from the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, a plurality of sections of a user interface associated with a collaboration session;
identifying an assigned first section of the plurality of sections of the user interface as a first screen share of a first computing device;
identifying an assigned second section of the plurality of sections of the user interface as a second screen share of a second computing device; and
applying control rules for display of the first section and the second section of the user interface to at least a portion of participants connected to the collaboration session.

2. The computer-implemented method of claim 1 wherein applying control rules includes applying a display filter to at least one of the first section and the second section of the user interface.

3. The computer-implemented method of claim 2 wherein the display filter includes a tag cloud based filtering.

4. The computer-implemented method of claim 2 wherein the display filter includes a group based filtering.

5. The computer-implemented method of claim 2 wherein the display filter includes a maximum number of sections of the user interface to be displayed.

6. The computer-implemented method of claim 1 wherein applying control rules includes preventing access to at least one of the first section and the second section of the user interface from one or more participants of at least the portion of participants connected to the collaboration session.

7. The computer-implemented method of claim 1 wherein applying control rules includes enabling individualized reorganization of the user interface from one or more participants of at least the portion of participants connected to the collaboration session.

8. A computer program product residing on a computer readable storage medium having a plurality of instructions stored thereon which, when executed by a processor, cause the processor to perform operations comprising:
identifying a plurality of sections of a user interface associated with a collaboration session;
identifying an assigned first section of the plurality of sections of the user interface as a first screen share of a first computing device;
identifying an assigned second section of the plurality of sections of the user interface as a second screen share of a second computing device; and
applying control rules for display of the first section and the second section of the user interface to at least a portion of participants connected to the collaboration session.

9. The computer program product of claim 8 wherein applying control rules includes applying a display filter to at least one of the first section and the second section of the user interface.

10. The computer program product of claim 9 wherein the display filter includes a tag cloud based filtering.

11. The computer program product of claim 9 wherein the display filter includes a group based filtering.

12. The computer program product of claim 9 wherein the display filter includes a maximum number of sections of the user interface to be displayed.

13. The computer program product of claim 8 wherein applying control rules includes preventing access to at least one of the first section and the second section of the user interface from one or more participants of at least the portion of participants connected to the collaboration session.

14. The computer program product of claim 8 wherein applying control rules includes enabling individualized reorganization of the user interface from one or more participants of at least the portion of participants connected to the collaboration session.

15. A computing system including a processor and a memory configured to perform operations comprising:
identifying a plurality of sections of a user interface associated with a collaboration session;
identifying an assigned first section of the plurality of sections of the user interface as a first screen share of a first computing device;
identifying an assigned second section of the plurality of sections of the user interface as a second screen share of a second computing device; and
applying control rules for display of the first section and the second section of the user interface to at least a portion of participants connected to the collaboration session.

16. The computing system of claim 15 wherein applying control rules includes applying a display filter to at least one of the first section and the second section of the user interface.

17. The computing system of claim 16 wherein the display filter includes a tag cloud based filtering.

18. The computing system of claim 16 wherein the display filter includes a group based filtering.

19. The computing system of claim 16 wherein the display filter includes a maximum number of sections of the user interface to be displayed.

20. The computing system of claim 15 wherein applying control rules includes preventing access to at least one of the first section and the second section of the user interface from one or more participants of at least the portion of participants connected to the collaboration session.
